(19) United States
(12) Patent Application Publication
(10) Pub. No.: US 2017/0270127 A1
(43) Pub. Date: Sep. 21, 2017

(54) CATEGORY-BASED FULL-TEXT SEARCHING

(71) Applicant: EMC IP Holding Company LLC, Hopkinton, MA (US)

(72) Inventors: Chao Chen, Shanghai (CN); Jingjing Liu, Shanghai (CN); Winston Lei Zhang, Shanghai (CN); Dingmeng Xue, Shanghai (CN); Zed Minhong Zhou, Shanghai (CN); Duke Hongtao Dai, Shanghai (CN)

(21) Appl. No.: 15/465,552

(22) Filed: Mar. 21, 2017

(30) Foreign Application Priority Data
Mar. 21, 2016 (CN) 201610162742.3

(51) Int. Cl. G06F 17/30

(52) U.S. Cl. CPC G06F 17/3071; G06F 17/30625; G06F 17/30011

(57) ABSTRACT

Various embodiments of the present disclosure provide a solution for category-based full-text searching. In some embodiments, there is provided a method of full-text searching. The method includes generating a first full-text index based on an obtained electronic document content. The method also includes categorizing the electronic document to determine a category identifier for the electronic document, and generating a second full-text index based on the category identifier. The method further includes storing the first full-text index and the second full-text index.

### RELATED APPLICATIONS

This application claim priority from Chinese Patent Application Number CN201610162742.3, filed on Mar. 21, 2016 at the State Intellectual Property Office, China, titled “Category-Based Full-Text Searching” the contents of which is herein incorporated by reference in its entirety.

### FIELD

Various embodiments of the present disclosure relate to the field of full-text searching and more specifically, to a method, apparatus, and system for category-based full-text searching.

### BACKGROUND

As rapid development of Internet and database technologies, information searching has become a prevailing demand. Full-text searching is an increasingly popular search method in the field of information searching.

In the full-text searching, generally a search engine parses content of an electronic document into full-text indexes and stores the full-text indexes in an index repository. Each of the full-text indexes may include one or more characters, words, symbols, or sentences of the electronic document. During the use, the search engine searches the index repository for a keyword input by a user and returns an electronic document corresponding to the matched full-text index. However, the user usually cannot be satisfied with the search result returned by such search process, particularly when there are a large number of full-text indexes from electronic documents stored in the index repository.

### SUMMARY

Various embodiments of the present disclosure provide a solution for category-based full-text searching.

In a first aspect of the present disclosure, there is provided a method of full-text searching. The method includes generating a first full-text index based on an obtained electronic document content. The method also includes categorizing the electronic document to determine a category identifier for the electronic document, and generating a second full-text index based on the category identifier. The method further includes storing the first full-text index and the second full-text index.

In a second aspect of the present disclosure, there is provided a method of full-text searching. The method includes obtaining a search term input by a user, the search term including at least a category keyword related to a category identifier for an electronic document to be searched. The method also includes matching the search term with one of a plurality of predefined full-text indexes. The plurality of full-text indexes including at least a first full-text index related to a category identifier determined by categorizing at least one electronic document. The method further includes determining an associated electronic document based on the matched full-text index.

In a third aspect of the present disclosure, there is provided an apparatus for full-text searching. The apparatus includes at least one processing unit; and at least one memory. The at least one memory is coupled to the at least one processing unit and stores instructions thereon, the instructions, when executed by the at least one processing unit, causing acts including: generating a first full-text index based on content of an obtained electronic document; categorizing the electronic document to determine a category identifier for the electronic document; generating a second full-text index based on the category identifier; and storing the first full-text index and the second full-text index.

In a fourth aspect of the present disclosure, there is provided an apparatus for full-text searching. The apparatus includes at least one processing unit; and at least one memory. The at least one memory is coupled to the at least one processing unit and stores instructions thereon, the instructions, when executed by the at least one processing unit, causing acts including: obtaining a search term input by a user, the search term including at least a category keyword related to a category identifier for an electronic document to be searched; matching the search term with one of a plurality of predefined full-text indexes, the plurality of full-text indexes including at least a first full-text index related to a category identifier determined by categorizing at least one electronic document; and determining an associated electronic document based on the matched full-text index.

In a fifth aspect of the present disclosure, there is provided a system for full-text searching. The system includes the apparatus for full-text searching according to the above third aspect. The system also includes the apparatus for full-text searching according to the above fourth aspect. The system further includes a full-text index repository configured to store the first full-text index and the second full-text index.

In a sixth aspect of the present disclosure, there is provided a computer-readable storage medium. The computer-readable storage medium has computer-readable program instructions stored thereon. These computer-readable program instructions are used for performing steps of the method according to the above first aspect.

In a seventh aspect of the present disclosure, there is provided a computer-readable storage medium. The computer-readable storage medium has computer-readable program instructions stored thereon. These computer-readable program instructions are used for performing steps of the method according to the above second aspect.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The above and other objectives, features and advantages of example embodiments disclosed herein will become apparent through the following detailed description with reference to the accompanying drawings. In embodiments of the present disclosure, the same or similar reference symbols refer to the same or similar elements.

FIG. 1 illustrates a schematic diagram of an environment in which various embodiments of the present disclosure can be implemented;

FIG. 2 illustrates a flowchart of a method of full-text searching in accordance with an embodiment of the present disclosure;

FIGS. 3A-3B illustrate schematic diagrams of two categories and their sub-categories which are stored as tree structures;

FIG. 4 illustrates a flowchart of a method of full-text searching in accordance with another embodiment of the present disclosure;

FIG. 5 illustrates a schematic block diagram of an example device suitable for implementing embodiments of the present disclosure.

### DETAILED DESCRIPTION

Some embodiments of the present disclosure will be described in more detail below with reference to figures. Although the figures illustrate some embodiments of the present disclosure, it would be appreciated that the present disclosure can be implemented in various manners and should not be limited by the embodiments set forth herein. Rather, these embodiments are provided for the purpose of enabling a throughout and complete disclosure and completely conveying the scope of the present disclosure to those skilled in the art

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The term “one example embodiment” and “an example embodiment” are to be read as “at least one example embodiment.” The term “another embodiment” is to be read as “at least one other embodiment.” The terms “first,” “second,” and the like may refer to different or same objects. Other definitions, explicit and implicit, may be included below.

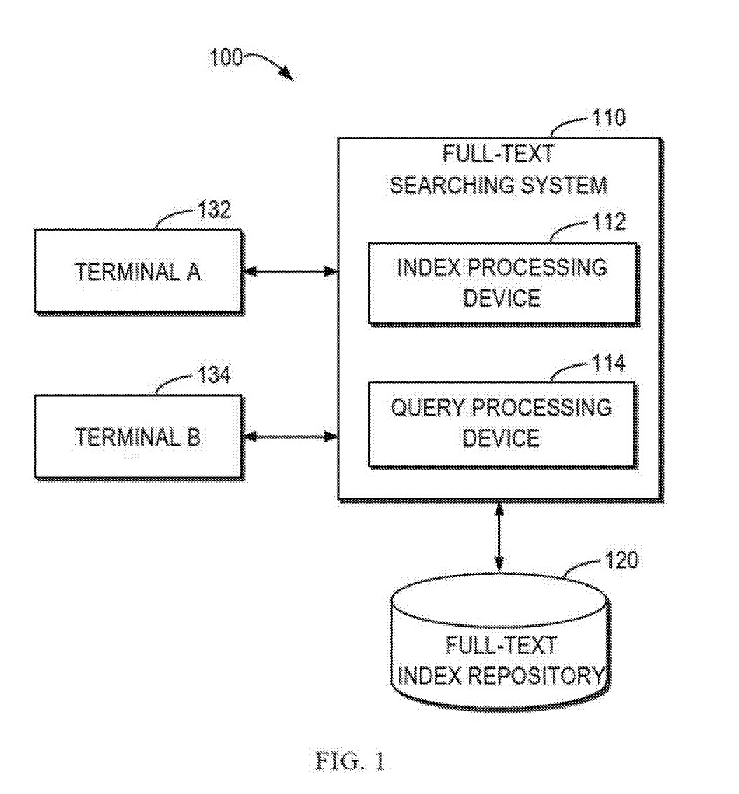

FIG. 1 illustrates a schematic diagram of an environment 100 in which a plurality of embodiments of the present disclosure can be implemented. The environment 100 includes a full-text searching system 110 which can be used to index one or more electronic documents and provide a search service for the user. The full-text searching system 110 may include an index processing device 112 which is configured to generate full-text indexes for the obtained electronic document(s). The index processing device 112 may store the generated full-text indexes in a full-text index repository 120. As used in the text herein, the term “electronic document” refers to any file in a machine-readable format, including but not limited to a pdf file, a txt file, various office files, various web files, and the like. The full-text searching system 110 may obtain the electronic documents from various data sources. For example, the full-text searching system 110 may crawl web files from one or more websites (not shown). In some examples, a user terminal, for example, a terminal A 132 and/or a terminal B 134, may provide various electronic documents to the full-text searching system 110.

Alternatively, or in addition to providing electronic documents to the full-text searching system 110, the terminal A 132 and/or terminal B 134 may utilize the full-text searching system 110 to query for desired electronic documents. For example, the terminal A 132 and/or terminal B 134 may send a query keyword input by the user to the full-text searching system 110. A query processing device 114 of the full-text searching system 110 may use the query keyword to look up a matched full-text index in the full-text index repository 120, and then provide an electronic document corresponding to the matched full-text index to the corresponding terminal. In some cases, the query processing device 114 may provide an address of the electronic document to the corresponding terminal so that the user of that terminal may obtain the corresponding electronic document based on the address. In some embodiments, the terminal A 132 and/or terminal B 134 may be connected to the full-text searching system 110 with a wired and/or wireless connection. The terminal A 132 and/or terminal B 134 may be any type of mobile, fixed, or portable terminal.

It would be appreciated that although being illustrated as two separate devices, in some embodiments, the index processing device 112 and query processing device 114 may be implemented by a single device such as a server or a computing device. In some other embodiments, the index processing device 112 and query processing device 114 may be implemented by a plurality of devices such as servers or computing devices. The full-text searching system 110 sometimes may be also referred to as a search engine.

In conventional full-text searching systems, content of an electronic document is parsed into one or more full-text indexes, each of which may include one or more characters, words, symbols, or sentences of the electronic document. The keyword input by the user is used to match with the full-text indexes so as to facilitate query for the electronic documents. As mentioned above, it is difficult for such full-text searching method to return desired electronic documents to the user. In some cases, by matching the keyword with the full-text indexes, a lot of electronic documents are returned so that the user finds it difficult to accurately obtain the desired content therefrom. For example, if the user wants to query for an electronic document written by “Tom” and related to “backup recovery” in the field of “data storage,” he/she may attempt to input keywords “data storage, backup recovery, Tom”. According to the user-input keyword, the full-text searching system may return a lot of electronic documents related to other aspects in data storage field or written by other authors. Such search results are inaccurate, which seriously affect the user experience.

According to embodiments of the present disclosure, there is provided a solution for full-text searching. When creating full-text indexes, in addition to a full-text index based on content of an electronic document, a further full-text index can be generated based on a categorizing result from categorizing, of the electronic document. Both the full-text index related to the document content and the full-text index related to the document category are stored in a full-text index repository, for example. Upon usage, the user can select a desired document category. Information related to the document category is considered as a search keyword which can be used with other keywords input by the user and related to the document content to search the full-text index repository. In this way, it is possible to search for an electronic document corresponding to a specific document category and document content from the full-text index repository, which thereby limiting the range of the search results and improving accuracy of the search results.

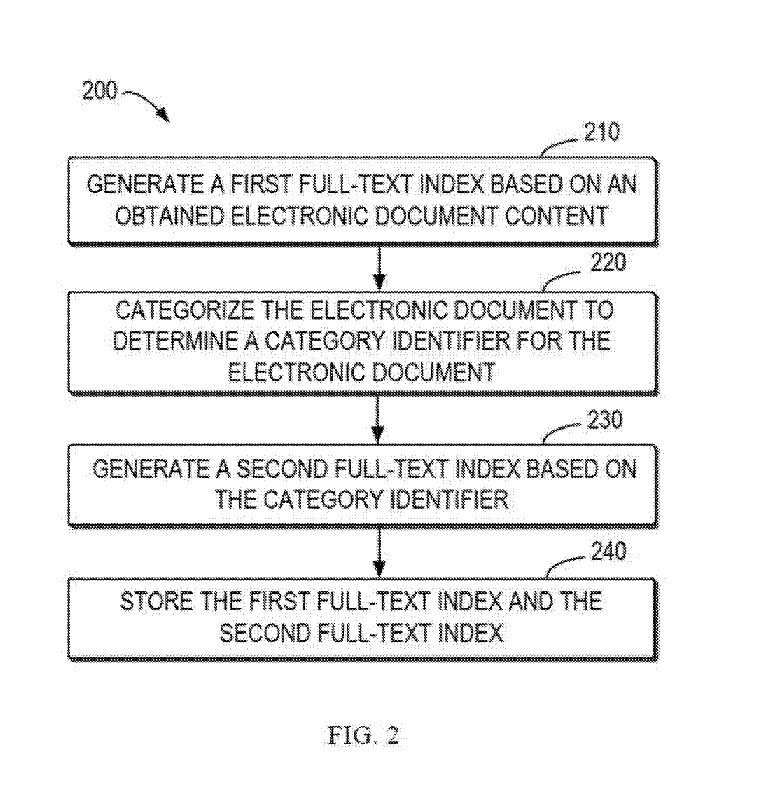

Reference is now made to FIG. 2, which illustrates a flowchart of a method of full-text searching 200 in accordance with an embodiment of the present disclosure. The method 200 can be used for creating full-text indexes, and can be implemented at, for example, the index processing device 112 of the full-text searching system 110. It is to be understood that the method 200 can further include additional steps and/or some shown steps can be omitted. The scope of the present disclosure is not limited in this regard.

At step 210, a first full-text index is generated based on content of an obtained electronic document. The first full-text index is a full-text index related to the document content. In some embodiments, the full-text searching system 110 may, for example, actively obtain a new created or updated electronic document from various data sources. Alternatively, or in addition, the data sources may actively transmit the new created or updated electronic document to the full-text searching system 110. The obtained electronic document may be any file in a machine-readable format and may include content of any human language or machine language. The index processing device 112 of the full-text searching system 110 may, for example, extract the content of the electronic document and divide the content of the electronic document into one or more full-text indexes, each of which can include one or more characters, words, symbols, or sentences. It would be appreciated that various techniques, whether currently used or to be developed in the future, can be employed to decompose the content of the electronic document into one or more full-text indexes.

Then, the method 200 proceeds to step 220, where the electronic document is categorized to determine a category identifier for the electronic document. In some embodiments, one or more document categories may be preset. These document categories can be set based on analysis of obtained electronic documents. Alternatively, or in addition, these document categories may also be set by the user or administrator of the full-text searching system 110. It would be appreciated that the categorizing of the documents is not limited in the present disclosure, and the documents can be categorized from various aspects. By way of example but not limitation, an electronic document can be determined as belonging to one or more categories based on one or more of the following: the author, creation time, creation location, modification time, document size, document format, document language, document topic, and accessible address of the document.

In some embodiments, metadata of an electronic document may be obtained, and thus the electronic document can be categorized based on the metadata associated with the electronic document. The metadata of the electronic document may include different descriptive information related to the electronic document. The metadata of the electronic document may include but is not limited to the author, creation time, creation location, modification time, document size, document format, document language, document topic, accessible address of the document, and the like. The metadata of the electronic document can be changed, and the type of information in the metadata of each electronic document can be varied. In some embodiments, the metadata may be obtained from the data source of the document. A creator of a document can also specify one or more items in the metadata of the document.

Alternatively, or in addition, the electronic document can be categorized by analyzing semantics of the content of the electronic document. The category of the document can be determined from the semantics of the content of the document by employing various techniques that are currently known or to be developed in the future. As an example, the document topic (for example the knowledge field to which the document belongs) can be determined by analyzing the document content. In another example, the document language (for example, Chinese language, English language, or other human or machine language) can be determined through semantic analysis. In other embodiments, an electronic document can be categorized manually by the user or administrator of the full-text searching system 110.

Therefore, in some embodiments, the document may be categorized into a corresponding predetermined category based on the metadata associated with the obtained electronic document or semantic analysis result. For example, if categories related to the author of the document, creation time, creation location, modification time, document side, document format and/or document topic are predefined, a corresponding category of the document of interest can be determined based on the information included in the metadata in the document. In some embodiments, only a rule of document categorization can be predetermined, and then corresponding categories are created based on metadata associated with an obtained document. For example, a rule for categorizing document authors can be set. If an author of a new obtained document belongs to a previously created category related to a specific author, the document is categorized into the existing category. If there is no category for the author of the new obtained document, a new author category can be created and the document can be categorized into the new created category. In some embodiments, a categorization rule for a plurality of categories can be predetermined, and then electronic documents are categorized according to the rules. For example, the document size may be classified into five categories of huge, large, medium, small, and void. A new obtained document can be associated with one of the five categories based on the size of that document.

In some embodiments, with a plurality of categories predefined, it can be determined whether the electronic document belongs to one or more of these categories. Usually, the plurality of categories can be used to categorize the electronic document from a plurality of aspects. In some embodiments, the electronic document can be categorized in a finer manner. One or more of the predefined categories may be further categorized into one or more sub-categories. Thus, upon determining a certain large category to which the new obtained electronic document belongs, if the category has one or more sub-categories, it can be further determined whether the electronic document belongs to one of the sub-categories. For example, for a category of a certain document topic, it is possible to further define a plurality of finer topics under this document topic. It would be appreciated that one or more sub-categories may be further categorized, and the scope of the present disclosure is not limited in this aspect

In some embodiments, the categories and sub-categories have their associated category identifiers to distinguish there between. For example, for a category of document author, the name of the author can be used as the identifier of the category. For other categories, the categories identifiers may be assigned in a similar manner. In some embodiments, after the obtained electronic document is determined as belonging to one or more categories, identifiers of these categories are determined as the identifiers of the electronic documents. If the electronic document belongs to a certain large category and also belongs to a certain sub-category under the category, both identifiers of the category and the sub-category may be determined as the identifiers of the electronic document.

In some embodiments, each predetermined category and its sub-category or categories can be stored in a tree structure. A root node of the tree structure may describe the category, and each predetermined category and its sub-category or categories may be regarded as sub-nodes in the tree structure. This tree structure may also be referred to as a decision tree. When a new electronic document is obtained, whether the electronic document belongs to the category or sub-category can be determined conveniently by traversing the tree structure, for example, by traversing each node in the tree structure. In some embodiments, each tree structure may be stored as a file. In other embodiments, a plurality of tree structures can also be stored as one file.

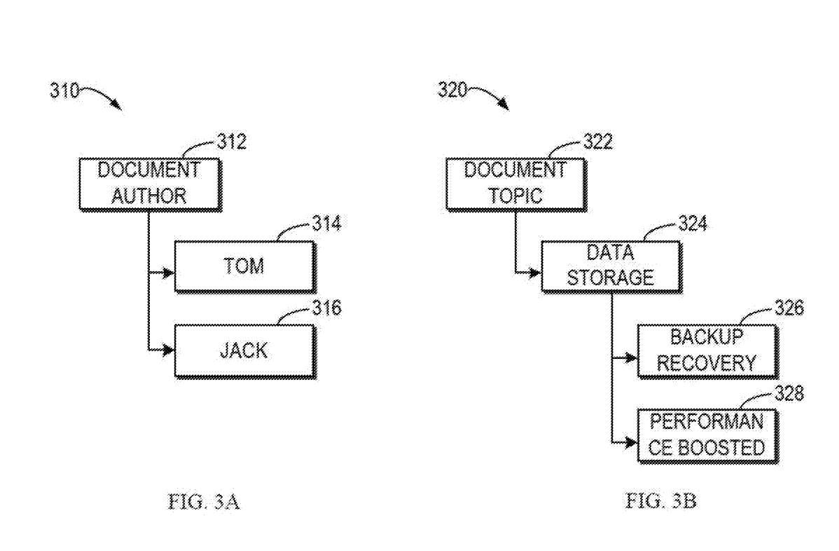

FIGS. 3A-3B illustrate schematic diagrams of two categories and their sub-categories which are stored as tree structures 310-320. In FIG. 3A, the tree structure 310 is related to a category of document author, where a root node 312 describes the tree structure, and sub-nodes 314 and 316 indicate two categories. In FIG. 3B, the tree structure 320 is related to the category of document topic, where a root node 322 describes the tree structure, and a sub-node 324 indicates one category. By traversing the tree structures 310 and 320, it is possible to determine whether an electronic document belongs to the category related to a certain author or whether the content included therein belongs to a certain topic and a sub topic under this topic.

In some embodiments, a tree structure can be dynamically increased. For example, if it is determined that an author of an electronic document does not belong to any one of the existing author categories, an additional node can be created as being related to a category of that author. Then, this electronic document can be categorized into this new category.

Still referring to FIG. 2, the method 200 proceeds to step 230, where a second full-text index is generated based on the category identifier The second full-text index is an index related to the category of the document. In some embodiments, the second full-text index can be generated as different from the first full-text index. For example, the first full-text index obtained from the content of the electronic document may also include a word related to a name of the document author. To avoid possible search errors, the second full-text index related to the category of document author can be determined as distinguishable from the first full-text index. For example, a prefix may be added into the second full-text index to distinguish the first full-text index related to the document content.

In an embodiment, the second full-text index may include a prefix portion and a description portion, where the prefix portion is used to distinguish the index related to the document category from the index related to the document content, and the description portion is used to describe the category identifier of the document. For example, if it is determined that an electronic document belongs to the category of the author “Tom,” it is possible to generate a prefix portion “DT_AUTHOR” related to the category of the document author and a description portion “Tom” related to the identifier of the category. In some embodiments, if the identifier of a predetermined category or sub-category can be determined as distinguishable from die first full-text index, then the category identifier can be directly determined as the second full-text index. For example, “DT_AUTHOR_Tom” may be used as an identifier for a category of the author “Tom,” and may be directly used as the second full-text index.

It would be appreciated that if it is determined at step 220 that the electronic document belongs to a plurality of categories or one or more sub-categories, the corresponding second full-text index may be generated in a similar manner based on the identifier of each category or sub-category.

At step 240 of the method 200, the first full-text index and the second full-text index may be stored. For example, the index processing device 112 of the full-text searching system 110 may store the first and second full-text indexes into the full-text index repository 120. In some embodiments, an accessible address of the electronic document may be stored in association with the first and second full-text indexes. In some other embodiments, original content of the electronic document may be stored in association with the first and second full-text indexes. In this way, when the electronic document is searched according to the first and second full-text indexes, the address or content of the electronic document can be presented to the user for access.

In some embodiments, a third full-text index can be generated and stored based on the metadata associated with the electronic document. For example, the third full-text index may be stored into the full-text index repository 120 together with the first and second full-text indexes. It would be appreciated that the third full-text index may include one or more characters, words, symbols or sentences in the content included by the metadata.

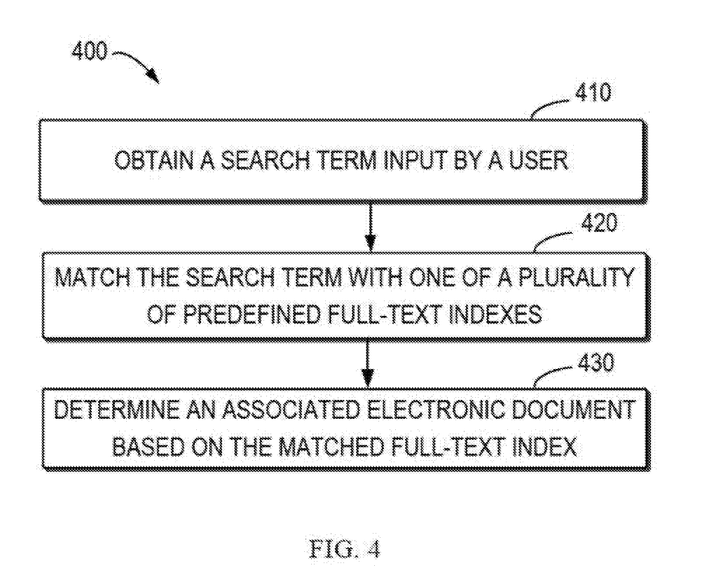

A process of creating full-text indexes has been described above with reference to FIG. 2. Once a new electronic document is received, the full-text indexes can be created for the electronic document according to the method 200 of FIG. 2. Next a method 400 of searching based on the created full-text indexes will be described with reference to FIG. 4. The method 400 can be implemented at, for example, the query processing device 114 of the full-text searching system 110. It is to be understood that the method 400 can further include additional steps and/or some shown steps can be omitted. The scope of the present disclosure is not limited in this regard.

At step 410, a search term input by a user is obtained. The user may send a query request via a terminal including the corresponding search term. In some embodiments, the search term may include a content keyword related to content of an electronic document to be searched which indicates that the user desires to obtain an electronic document(s) whose content includes the specified keyword. In some embodiments, the search term further includes a category keyword related to a category identifier for the electronic document to be searched. After the full-text index or indexes are created based on the document category or categories, it is possible to provide the user with a user interface so that the user can select a corresponding category. In some embodiments, options corresponding to one or more predetermined categories can be provided for example via the user interface on the terminal of the user. The user can determine the category of the desired electronic document by selecting these options. In some embodiments, for a large category including one or more sub-categories, it is also possible to continue to provide the user with options corresponding to the sub-categories for selection. The provided options can be indicated by identifiers of the corresponding categories or sub-categories.

In some embodiments, a category keyword can be determined based on an identifier(s) of the corresponding category (categories) or sub-category (sub-categories) in response to the user selection of one or more options. Different from the content keyword (which may be a keyword directly input by the user) related to the content of the document, the category keyword is generated by the user selection of the category or sub-category of the document. For example, if the user wants to obtain a document written by the author “Tom” and thus selects an option corresponding to the category of the author, “DT_AUTHOR_Tom” can be generated as the category keyword. Alternatively, or in addition to providing the user with options for selection, the user may also directly input a keyword similar to the type of the full-text index for the category of the created document, for example, “DT_AUTHOR_Tom,” to facilitate retrieving of the electronic document(s) in this category.

Next, at step 420 of the method 400, the search term is matched with one of a plurality of predetermined full-text indexes. As described in the method 200 above, the plurality of full-text indexes include a first full-text index related to the document content and a second full-text index related to the document category. In some embodiments, each keyword in the search term, including a document content keyword and a category keyword may be compared with each of the full-text indexes. If a full-text index includes one or more of the keywords, it can be determined that this full-text index successfully matches with the keyword(s).

In some embodiments, a constraint relationship between keywords of the search term can be set. For example, a plurality of keywords related to the document content can be in an “and” or “or” relationship. A plurality of keywords related to the document category can be in an “and” or “or” relationship, and the keywords determined based on sub-categories under each category may be in an “or” relationship. In some embodiments, the matching may be performed in a plurality of full-text indexes associated with each electronic document based on these constraint relationships. As an example, it is supposed that the user inputs the document content keywords “speed improved” and “storage space is valid.” The user selects the author category of “Tom,” the document topic category of “data storage” and its sub-categories of “backup recovery” and “performance boosted.” After the corresponding category keywords are obtained, it is possible to look up, among the full-text indexes corresponding to each electronic document, full-text indexes that are successfully matched with the keywords related to “Tom” and “data storage” and “backup recovery” or “performance boosted.” Additionally, it is determined whether the full-text indexes of the electronic document further include full-text indexes that are successfully matched with the two content keywords “speed improved” and “storage space”. If it is found in the full-text indexes of a certain electronic document that the category keyword and the document content keyword of the search term are successfully matched, it may be determined that electronic documents corresponding to these full-text indexes successfully match the search term of the user. In some cases where high accuracy is not required, if the full-text indexes of a certain electronic document successfully match with one or more of all the keywords, it may be determined that the result is successfully matched.

At step 430 of the method 400, an associated electronic document is determined based on the matched full-text index. The full-text indexes are searched with the search term. If a full-text index or indexes satisfying the condition are found, the electronic document(s) corresponding to that index or indexes can be returned to the user as a search result. In some embodiments, an accessible address of the electronic document can be returned to the user. In some embodiments, the search result may be provided to the user according to a matching degree. The matching degree may be determined according to the number of successful matches of the full-text indexes associated with the electronic document and the keywords in the search term.

Various embodiments of the present disclosure have been described above with reference to FIG. 2 and FIG. 4. Through the full-text searching method according to the present disclosure, a more accurate search result can be provided to the user. In some embodiments, since electronic documents are categorized, it is possible to find out a document with a blank content. This is because although a full-text index related to the document content cannot be generated since the document content is blank, the full-text index corresponding to the document category can also be generated for the electronic document based on the categorization result. Upon searching, the user may query for the document by defining a corresponding category.

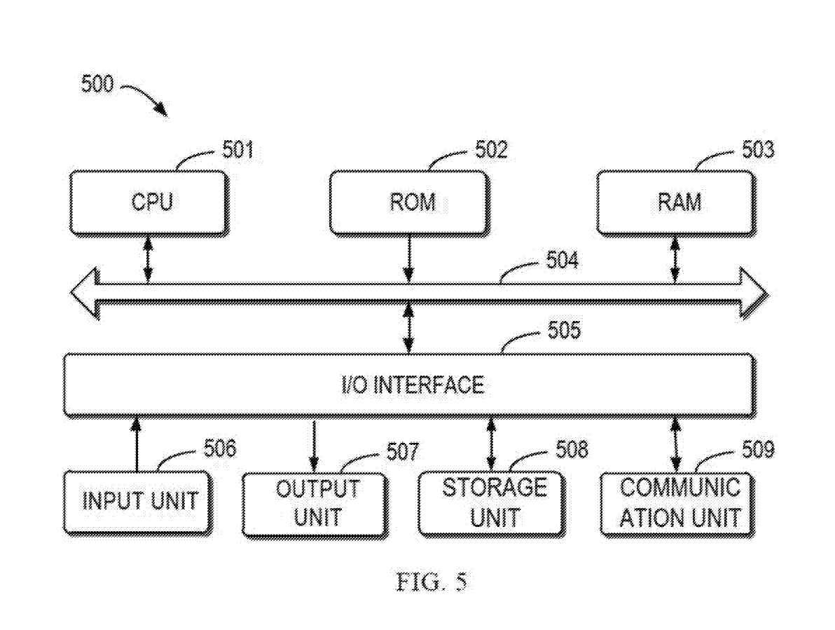

FIG. 5 illustrates a schematic block diagram of an example device 500 suitable for implementing embodiments of the present disclosure. The device 500 can be used to implement an index processing device 112 and/or query processing device 114 of FIG. 1. As shown, the device 500 includes a central processing unit (CPU) 501 which is capable of performing various suitable actions and processes in accordance with computer program instructions stored in a read only memory (ROM) 502 or loaded from a storage unit 508 to a random access memory (RAM) 503. In the RAM 503, various programs and data required for operation of the device 500 may also be stored. The CPU 501, ROM 502, and RAM 503 are connected to one another via a bus 504. An input/output (I/O) interface 505 is also connected to the bus 504.

Various components in the device 500 are connected to the I/O interface 505, including an input unit 506 such as a keyboard, a mouse, and the like; an output unit 507 such as various kinds of display, loudspeakers, and the like; the storage unit 508 such as a magnetic disk, an optical disk, and the like; and a communication unit 509 such as a network card, a modem, a radio communication transceiver, and the like. The communication unit 509 enables the device 500 to communicate information/data with other devices via a computer network such as Internet and/or various telecommunication networks.

The methods and processes such as the method 200 and/or method 400 described above can be implemented with the processing unit 501. For example, in some embodiments, the method 200 and/or method 400 may be implemented as computer software programs, which are tangibly included in a machine-readable medium such as the storage unit 508. In some embodiments, part or all of the computer programs may be loaded and/or installed on the device 500 via the ROM 502 and/or the communication unit 509. When the computer program is loaded to the RAM 503 and executed by the CPU 501, one or more steps of the above method 200 and/or method 400 can be performed.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can maintain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination thereof. A list of specific but not exclusive examples of the computer readable storage medium includes a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination thereof. A computer readable storage medium, as used herein, is not to be construed as transitory signals such as radio waves or other freely propagating electromagnetic waves, electromagnetic waves propagating through a waveguide or other transmission media (for example, light pulses passing through a fiber-optic cable), or electrical signals transmitted through a wire line.

Computer readable program instructions described herein can be downloaded to respective computing/processing devices from a computer readable storage medium or to an external computer or external storage device via a network, for example, the Internet, a local area network, a wide area network, and/or a wireless network. The network may include copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, or the like, and conventional procedural programming languages such as the “C” programming language or similar programming languages. The computer readable program instructions may execute entirely on the user computer, partly on the user computer, as a stand-alone software package, partly on the user computer and partly on a remote computer or entirely on the remote computer or server. In the latter scenario, the remote computer may be connected to the user computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to customize the electronic circuitry, in order to perform aspects of the present disclosure.

Aspects of the present disclosure described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a process of a general purpose computer, special purpose computer, or other programmable data processing apparatus to produce a machine, such that the instructions, which executed by the processor of the computer or other programmable data processing apparatus, create means for implementing the functions/actions specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored thereon comprises an article of manufacture including instructions which implement aspects of the functions/actions specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions, which executed on the computer, other programmable apparatus, or other device, implement the functions/actions specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The description of various embodiments of the present disclosure has been presented for purposes of illustration but not exhaustive, and is not intended to limit the embodiments disclosed. Various modifications and variations will be apparent to those ordinary skilled in the an without departing from the scope and spirit of the described embodiments. The terminology used herein is chosen to best explain the principles of the embodiments, the practical application, or technical improvement over technologies in the art, or to enable other ordinary skilled in the art to understand the embodiments disclosed herein.

1. A method of full-text searching, comprising:
Generating a first full-text index based on content of an obtained electronic document;
Categorizing the electronic document to determine a category identifier for the electronic document;
Generating a second full-text index based on the category identifier; and
storing the first full-text index and the second full-text index.

2. The method according to claim 1, wherein categorizing the electronic document comprises at least one of:
Categorizing the electronic document based on metadata associated with the electronic document; Or
categorizing the electronic document by analyzing semantics of the content of the electronic document.

3. The method according to claim 1, wherein categorizing the electronic document comprises:
Determining whether the electronic document belongs to a predetermined category; And
in response to determining that the electronic document belongs to the predetermined category, determining a category identifier associated with the predetermined category as the category identifier for the electronic document.

4. The method according to claim 3, wherein categorizing the electronic document further comprises:
in response to determining that the electronic document belongs to the predetermined category, determining whether the electronic document belongs to a sub-category of the predetermined category; and
in response to determining that the electronic document belongs to the sub-category, determining a category identifier associated with the sub-category as the category identifier for the electronic document.

5. The method according to claim 3, wherein the predetermined category and the sub-category are stored in a tree structure, and
wherein categorizing the electronic document comprises:
Determining the category identifier for the electronic document by traversing the tree structure.

6. The method according to claim 1, further comprising:
Generating a third full-text index based on metadata associated with the electronic document; And
storing the third full-text index.

7. A method of full-text searching, comprising:
Obtaining a search term input by a user, the search term including at least at category keyword related to a category identifier for an electronic document to be searched;
Matching the search term with one of a plurality of predefined full-text indexes, the plurality of full-text indexes including at least a first full-text index related to a category identifier determined by categorizing at least one electronic document; And
determining an associated electronic document based on the matched full-text index.

8. The method according to claim 7, wherein the search term further includes a content keyword related to content of the electronic document to be searched, and the plurality of full-text indexes further include a second full-text index generated based on content of the at least one electronic document.

9. The method according to claim 7, wherein obtaining a search term input by a user comprises:
Providing the user with a first option corresponding to the predetermined category; And
in response to selection of the first option by the user, determining the category keyword based on the category identifier of the predetermined category.

10. The method according to claim 9, wherein obtaining a search term input by a user further comprises:
Providing the user with a second option corresponding to a sub-category of the predetermined category; And
in response to selection or the second option by the user, determining the category keyword based on category identifier of the sub-category.

11. An apparatus for full-text searching, comprising:
At least one processing unit; And
at least one memory coupled to the at least one processing unit and storing instructions thereon, the instructions, when executed by the at least one processing unit, causing acts including:
Generating a first full-text index based on content of an obtained electronic document;
Categorizing the electronic document to determine a category identifier for the electronic document;
Generating a second full-text index based on the category identifier; And
storing the first full-text index and the second full-text index.

12. The apparatus according to claim 11, wherein categorizing the electronic document comprises at least one of:
Categorizing the electronic document based on metadata associated with the electronic document; Or
categorizing the electronic document by analyzing semantics of the content of the electronic document.

13. The apparatus according to claim 11, wherein categorizing the electronic document comprises:
Determining whether the electronic document belongs to a predetermined category; And
in response to determining that the electronic document belongs to the predetermined category, determining a category identifier associated with the predetermined category as the category identifier for the electronic document.

14. The apparatus according to claim 13, wherein categorizing the electronic document further comprises:
In response to determining that the electronic document belongs to the predetermined category, determining whether the electronic document belongs to a sub-category of the predetermined category; And
in response to determining that the electronic document belongs to the sub-category, determining a category identifier associated with the sub-category as the category identifier for the electronic document.

15. The apparatus according to claim 13, wherein the predetermined category and the sub-category are stored in a tree structure, and
wherein the categorizing the electronic document comprises:
Determining the category identifier for the electronic document by traversing the tree structure.

16. The apparatus according to claim 11, wherein the acts further include:
Generating a third full-text index based on metadata associated with the electronic document; And
storing the third full-text index.

17-23. (canceled)
